(19) United States
(12) Patent Application Publication
(10) Pub. No.: US 2005/0169699 A1
(43) Pub. Date: Aug. 4, 2005

(54) Locking apparatus for cookware

(76) Inventor: Dave Whitmer, Oxnard, CA (US)

Correspondence Address: LAW OFFICE OF MICHAEL P. EDDY, 12526 HIGH BLUFF DRIVE, STE. 300, SAN DIEGO, CA, 92130, US

(21) Appl. No.: 10/806,798

(22) Filed: Mar. 23, 2004

Related U.S. Application Data
(60) Provisional application No. 60/481,969, filed on Jan. 30, 2004.

(51) Int. Cl. F16B 7/10

(52) U.S. Cl. 403/109.1

(57) ABSTRACT

One embodiment of the present invention includes a locking apparatus for cookware with two opposing surfaces comprising a stationary sleeve with a handle positioned at the end, a stationary pin with a positioning collar, a semi-circular collar accommodating a rotation limiting latch pin and shoulder stop wherein said semi-circular collar is interlocked with said stationary pin, a round shaft accommodating lateral movement limiting rings, wherein said shaft is inserted through said stationary sleeve, and wherein said stationary sleeve is attached to one opposing cookware surface. Another embodiment of the present invention further includes the capability of the handle to be used to lift one opposing cookware surface away from the other opposing cookware surface. Another embodiment of the present invention comprises a circular collar instead of a semi-circular collar. Another embodiment of the present invention includes a return spring. Another embodiment of the present invention includes a semi-circular collar comprised of circular collar accommodating a rotation limiting latch pin and two shoulder stops, wherein one of said shoulder stop limits movement of said shaft in the counter-clockwise direction and the other said shoulder stop limits movement of said shaft in the clockwise direction. Another variation of this embodiment further consists of a handle which can rotate the range between approximately 20 degrees and 60 degrees. Another embodiment of the present invention further includes a feature wherein the locking apparatus is detachable from the cookware.

### CROSS-REFERENCES TO OTHER RELATED PATENT APPLICATIONS

This application claims priority to U.S. provisional application Ser. No. 60/456,740 filed Mar. 21, 2003 and U.S. provisional patent application Ser. No. 60/481,969, filed Jan. 31, 2004, both of which are incorporated herein by reference in their entireties.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The present invention relates generally to the field of cookware, and more specifically cookware that have handles and which interlock more than one sections or portions of the cookware.

Most varieties and styles of cookware use handles and some of these cooking apparatuses use locking features to lock the lid or the top portion of the cookware to the base or one opposable surface to another. Most existing cooking wares that employ these locking features are in general difficult to use because they require the cook to use two hands to operate the lock. For example, some pots and pans found in the prior art have lockable lids with snap down locking handles on each side of the pot. In these items, the locks are integrated into the pot handles and the pots require the cook to separately lock and unlock each side of the pot in order to use the locking feature properly. The handles are designed to stay cool on the stovetop and are generally made of phenolic materials.

### BRIEF SUMMARY OF THE INVENTION

One embodiment of the present invention includes a locking apparatus for cookware with two opposing surfaces comprising a stationary sleeve with a handle positioned at the end, a stationary pin with a positioning collar, a semi-circular collar accommodating a rotation limiting latch pin and shoulder stop wherein said semi-circular collar is interlocked with said stationary pin, a round shaft accommodating lateral movement limiting rings, wherein said shaft is inserted through said stationary sleeve, and wherein said stationary sleeve is attached to one opposing cookware surface.

Another embodiment of the present invention further includes the capability of the handle to be used to lift one opposing cookware surface away from the other opposing cookware surface.

Another embodiment of the present invention comprises a circular collar instead of a semi-circular collar.

Another embodiment of the present invention includes a return spring.

Another embodiment of the present invention includes a semi-circular collar comprised of circular collar accommodating a rotation limiting latch pin and two shoulder stops, wherein one of said shoulder stop limits movement of said shaft in the counter-clockwise direction and the other said shoulder stop limits movement of said shaft in the clockwise direction. Another variation of this embodiment further consists of a handle which can rotate the range between approximately 20 degrees and 60 degrees.

Another embodiment of the present invention further includes a feature wherein the locking apparatus is detachable from the cookware.

### BRIEF DESCRIPTION OF THE SEVERAL VIEWS OF THE DRAWINGS

The above and other objects, advantages and features of the present invention will be more readily apparent from the following description, when read in conjunction with the accompanying drawings wherein:

FIG. 1 is a side view of a cookware article with an embodiment of the present invention;

FIG. 2 is a perspective view of a cookware article with an embodiment of the present invention;

FIG. 3 is a top view of a cookware article with an embodiment of the present invention;

FIG. 4 is a top view of a cookware article with an embodiment of the present invention;

FIG. 5 is an exploded view of an embodiment of the present invention.

### DETAILED DESCRIPTION OF THE INVENTION

Turning now descriptively to the drawings, in which similar reference characters denote similar elements throughout several views, FIG. 1 is a side view of a cookware article with an embodiment of the present invention in its ready to cook position. It includes two opposing cooking surfaces (A&E), a handle(B), a detachable hinge mechanism(C&F), and a lifting/lock actuating handle(H) and a latch pin(J) of the present invention.

The cookware article is secured together by the hinge and locking apparatus. FIG. 2 is a perspective view of a cookware article with an embodiment of the present invention with a hinge assembly connected and includes two opposing cooking surfaces (A&E), a handle (B), a detachable hinge mechanism (C&F), a locking pin (D), a lifting/lock actuating handle (H), a latch pin (J) and a upper shoulder stop (O).

In this embodiment, both cooking surface components are placed on separate stove top burners with flames on high for preheating. After approximately two minutes, frozen food is placed in the bottom component A and the flame under the bottom component A is then lowered. The handle H is used to lift the top component E from the burner and the hinge F of the top component is placed into hinge C of the bottom component A joining the components A and E. Top component E is lowered onto bottom component A. Locking pin J on component A is accommodated inside the semi circular collar G of the locking apparatus.

Lifting handle H is rotated clockwise until the latch pin J abuts to the handle H and this completed action secured bottom component A and top component E together. A predetermined level of heat is applied to the bottom component A with a flame for an amount of time. To stir the food inside the cookware article, the user grasps the handle B located on the bottom component A and rotates or flips the cookware article 180 degrees placing the top component E on the heat source. This action is repeated until the food is cooked to a desired consistency and the heat is removed. An alternative method to stir or agitate the food is to grasp handle B and shake vigorously with a back and forth motion. Yet another method would be to unlock top component E, lift apart from component A and manually stir the food found in component A. In another method to stir food that produces excess liquids, grasp handle and tilt cookware article to the side and drain the excess liquid out before flipping. To stop cooking and separate the cookware article after the food has been cooked, ensure that the bottom component A is closest to the bottom heat source and rotate the lifting handle H counterclockwise until shoulder stop abuts the top component E. This unlocks the locking mechanism. With lifting handle H, lift top component E away from bottom component A, disengage hinge F from hinge C, and separate the components. The food can then be served from the bottom component A. It is also possible to separate the top and bottom components A and E with the top component E positioned on the heat source.

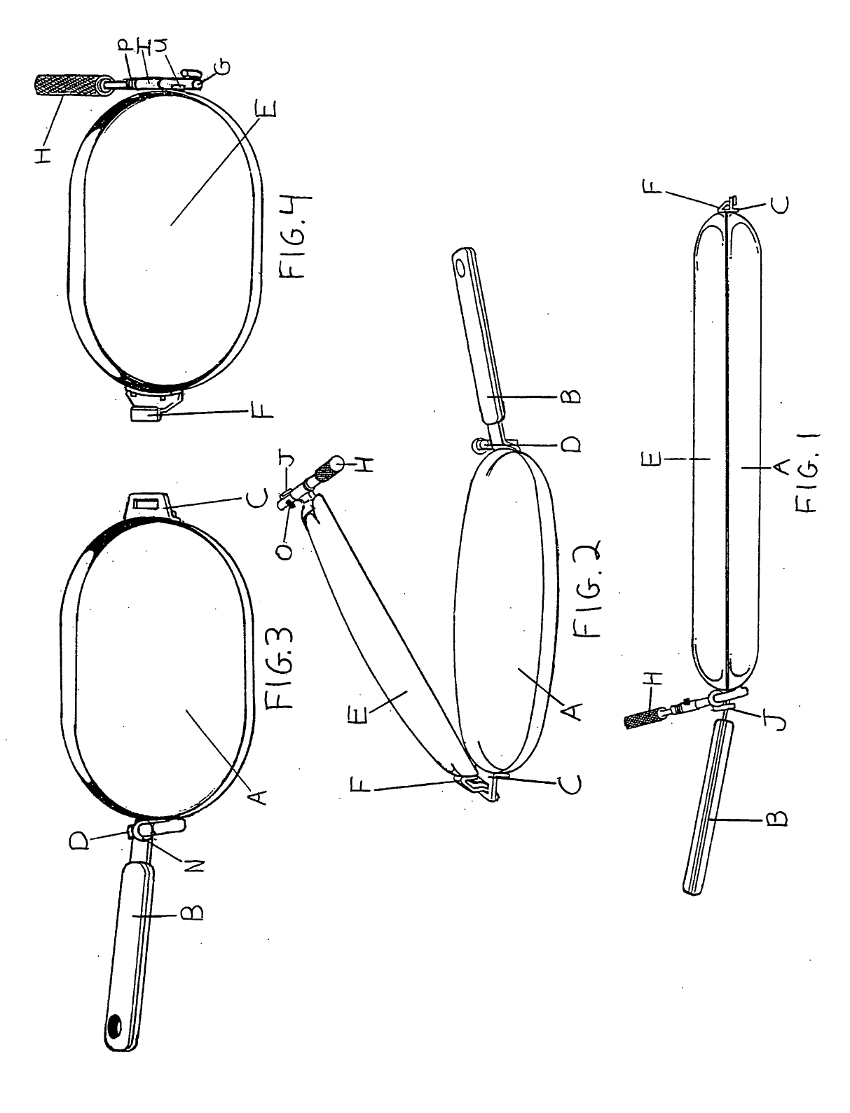

FIG. 3 is a top view of a cookware article with an embodiment of the present invention, showing the cooking side of the bottom component A, including handle B, the slotted component of the detachable hinge C affixed to cooking surface of bottom component A, the locking pin D affixed to the cooking surface of component A and the positioning collar N.

FIG. 4 is a top view of a cookware article with an embodiment of the present invention showing the cooking side of the top component, and includes a lifting/lock actuating handle (H), a return spring(P), a sleeve(I) affixed to cooking surface(E) a lower shoulder stop(U), a circular collar(G), and the tongued component of the detachable hinge(F) affixed to the cooking surface(E).

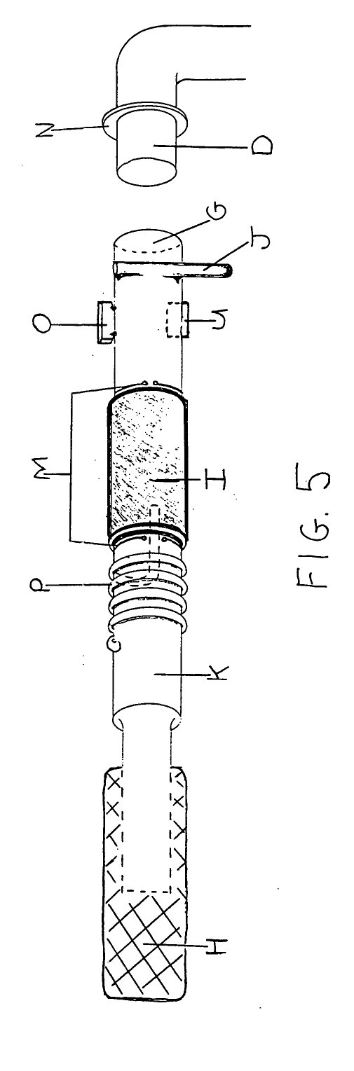

FIG. 5 is an exploded view of an embodiment of the present invention; showing in detail the locking mechanism and includes a handle(H), attached to a shaft(K), with a return spring(P), a sleeve(I), 2 external retaining rings(M), an upper shoulder stop(O), a lower shoulder stop(U), a latch pin(J), circular collar(G), a locking pin(D) and a positioning collar(N).

In the aforementioned views, the locking apparatus utilizes a stationary pin with a positioning collar that interlocks with a semi-circular collar with a rotation limiting latch pin and shoulder stop attached to a round shaft with lateral movement limiting retaining rings inserted through a stationary sleeve with a handle on the end. This handle serves the dual purposes of both lifting the top component (the top opposing surface of the cookware) and either engaging or disengaging the locking mechanism. The handle can be made of any material suitable to cookware that is heat resistant. The locking apparatus can also be detachable from the cookware to aid with cleaning.

In another embodiment, the locking apparatus consists of a locking pin with a positioning collar that interlocks with a circular collar with a latch pin and 2 rotation limiting shoulder stops, attached to a round shaft with lateral movement limiting retaining rings, inserted through a stationary sleeve with a handle on the end. The lifting handle can be made of a heat resistant phenolic material for comfort and for resistance to heat but any suitable material will suffice for the purpose of the invention.

While the present invention has been illustrated and described by means of specific embodiments and alternatives, it is to be understood that numerous changes and modifications can be made without departing from the spirit and scope of the invention. Therefore, it should be understood that the invention is not to be limited in any way except in accordance with the appended claims and their equivalent.

1. A locking apparatus for cookware with two opposing surfaces comprising:
a stationary sleeve with a handle positioned at the end;
a stationary pin with a positioning collar;
a semi-circular collar accommodating a rotation limiting latch pin and shoulder stop wherein said semi-circular collar is interlocked with said stationary pin;
a round shaft accommodating lateral movement limiting rings;
wherein said shaft is inserted through said stationary sleeve; and
wherein said stationary sleeve is attached to one opposing cookware surface.

2. A locking apparatus of claim 1 wherein the handle is further used to lift one opposing cookware surface away from the other opposing cookware surface.

3. A locking apparatus of claim 1 wherein said semi-circular collar is a circular collar.

4. A locking apparatus of claim 1 further comprising a return spring.

5. A locking apparatus of claim 1 wherein said a semi-circular collar is comprised of circular collar accommodating a rotation limiting latch pin and two shoulder stops, wherein one of said shoulder stop limits movement of said shaft in the counter-clockwise direction and the other said shoulder stop limits movement of said shaft in the clockwise direction.

6. A locking apparatus of claim 5 wherein the rotation of said handle is in the range of approximately 20 degrees and 60 degrees.

7. A locking apparatus of claim 1 wherein said locking apparatus is detachable from the cookware.
